(19) United States
(12) Patent Application Publication
(10) Pub. No.: US 2026/0161378 A1
(43) Pub. Date: Jun. 11, 2026

(54) OUT-OF-BAND COMPONENT UPDATE SYSTEM

(71) Applicant: Dell Products L.P., Round Rock, TX (US)

(72) Inventors: Wei Liu, Austin, TX (US); Kiran George Vetteth, Leander, TX (US)

(21) Appl. No.: 18/976,430

(22) Filed: Dec. 11, 2024

(51) Int. Cl. G06F 8/65; G06F 9/4401

(52) U.S. Cl. CPC G06F 8/65; G06F 9/4401

(57) ABSTRACT

An OOB component update system includes a computing device having BMC device coupled to a component. The BMC device receives a component update request that includes a component update image for updating the component, and a component update plugin. The BMC device then retrieves runtime parameter(s) for the computing device, and executes the component update plugin to determine whether the component update image is compatible with the runtime parameter(s). In response to the execution of the component update plugin determining that the component update image is not compatible with the runtime parameter(s), the BMC device prevents the updating of the component using the component update image. In response to the execution of the component update plugin determining that the component update image is compatible with the runtime parameter(s), the BMC device allows the updating of the component using the component update image.

### BACKGROUND

The present disclosure relates generally to information handling systems, and more particularly to Out-Of-Band (OOB) updating of components in an information handling system.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as, for example, server devices and other computing devices known in the art, include components that may need to be updated. For example, server devices include a Basic Input/Output System (BIOS) that is configured to perform hardware initialization for the server device during boot and provide runtime operations for an operating system and/or applications on the server device during runtime, and may be updated periodically to enhance BIOS functionality, ensure BIOS security, and/or provide other BIOS update benefits that would be apparent to one of skill in the art in possession of the present disclosure. While BIOS updates have traditionally been handled by the BIOS, computing device providers have begun shifting the updating of the BIOS to an “Out-Of-Band” (OOB) BIOS update process that is handled by a Baseboard Management Controller (BMC) in the server device, but such OOB BIOS updates are subject to several issues.

For example, in conventional OOB BIOS update systems, the BMC in the server device receives a BIOS update request including a BIOS update image for updating the BIOS in the server device, and checks whether the BIOS update image was developed for use in updating a BIOS for that server device by determining whether the BIOS update image includes a server device identifier for the server device (e.g., whether the BIOS update image that provides an update for the BIOS in the server device includes a server platform identifier for a server platform that includes that server device). If the BMC determines that the BIOS update image was developed for use in updating a BIOS for its server device, it then “stages” the BIOS update image (e.g., by providing the BIOS update image in a memory that is shared with the BIOS). The server device will then subsequently be rebooted (e.g., via a forced reboot, a scheduled reboot, etc.), and the BIOS will initiate a BIOS update process by retrieving the BIOS update image staged by the BMC and performing a runtime compatibility check using runtime parameters for the server device that are accessible to the BIOS but that are conventionally unavailable to the BMC. In the event the runtime compatibility check fails, the BIOS update process will fail, and the BIOS update must be reattempted similarly as described above. Such runtime compatibility check failures during the BIOS update process result in server device unavailability, and that server device unavailability is exacerbated when users are required to reboot server devices several times in order to successfully update their BIOS.

Accordingly, it would be desirable to provide an Out-Of-Band component update system that addresses the issues discussed above.

### SUMMARY

According to one embodiment, an Information Handling System (IHS) includes a Baseboard Management Controller (BMC) processing system; and a BMC memory system that is coupled to the BMC processing system and that includes instructions that, when executed by the BMC processing system, cause the BMC processing system to provide an Out-Of-Band (OOB) component update engine that is configured to: receive a component update request that includes a component update image that is configured to update a component, and a component update plugin; retrieve at least one runtime parameter for a computing device that includes the component and a BMC device having the BMC processing system and the BMC memory system; execute the component update plugin to determine whether the component update image is compatible with the at least one runtime parameter for the computing device; prevent, in response to the execution of the component update plugin determining that the component update image is not compatible with the at least one runtime parameter for the computing device, the updating of the component using the component update image; and allow, in response to the execution of the component update plugin determining that the component update image is compatible with the at least one runtime parameter for the computing device, the updating of the component using the component update image.

### BRIEF DESCRIPTION OF THE DRAWINGS

FIG. 1 is a schematic view illustrating an embodiment of an Information Handling System (IHS).

FIG. 2 is a schematic view illustrating an embodiment of a computing device that may include the Out-Of-Band component update system of the present disclosure.

FIG. 3 is a flow chart illustrating an embodiment of a method for performing Out-Of-Band (OOB) updates for a component in a computing device.

FIG. 4 is a schematic view illustrating an embodiment of the computing device of FIG. 2 operating during the method of FIG. 3.

FIG. 5 is a schematic view illustrating an embodiment of the computing device of FIG. 2 operating during the method of FIG. 3.

FIG. 6 is a schematic view illustrating an embodiment of the computing device of FIG. 2 operating during the method of FIG. 3.

FIG. 7 is a schematic view illustrating an embodiment of the computing device of FIG. 2 operating during the method of FIG. 3.

FIG. 8 is a schematic view illustrating an embodiment of the computing device of FIG. 2 operating during the method of FIG. 3.

FIG. 9 is a schematic view illustrating an embodiment of the computing device of FIG. 2 operating during the method of FIG. 3.

FIG. 10A is a schematic view illustrating an embodiment of the computing device of FIG. 2 operating during the method of FIG. 3.

FIG. 10B is a schematic view illustrating an embodiment of the computing device of FIG. 2 operating during the method of FIG. 3.

FIG. 10C is a schematic view illustrating an embodiment of the computing device of FIG. 2 operating during the method of FIG. 3.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

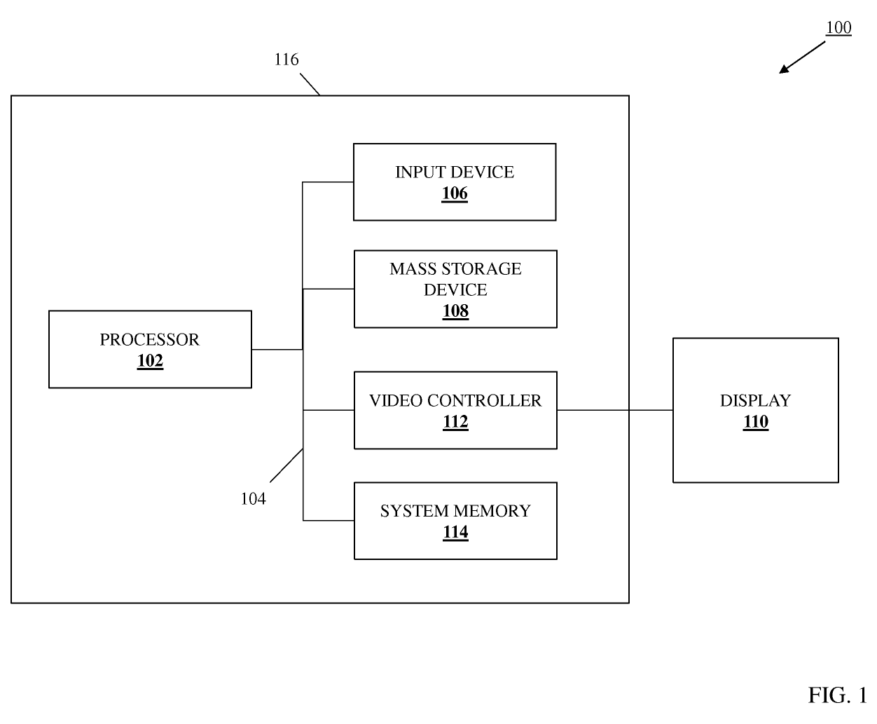

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

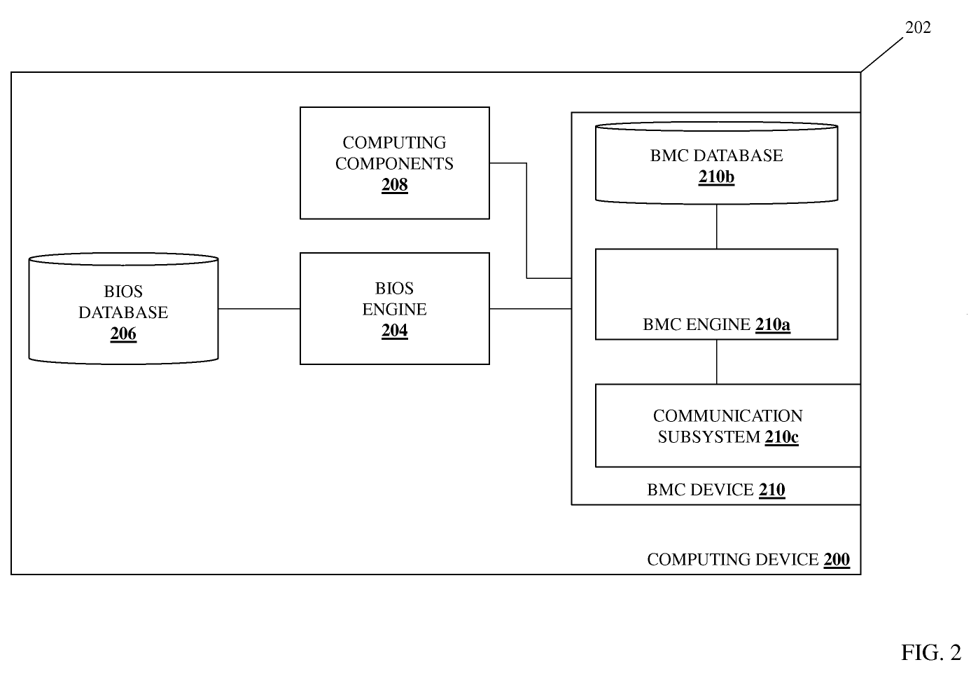

Referring now to FIG. 2, an embodiment of a computing device 200 is illustrated that may include the Out-Of-Band (OOB) component update system of the present disclosure. In an embodiment, the computing device 200 may be provided by the IHS 100 discussed above with reference to FIG. 1, and/or may include some or all of the components of the IHS 100, and in specific examples may be provided by a server device. However, while illustrated and discussed as being provided by a server device, one of skill in the art in possession of the present disclosure will recognize that computing devices providing the OOB component update system of the present disclosure may include networking devices (e.g., switch devices), storage systems, and/or other computing devices that may be configured to operate similarly as the computing device 200 discussed below.

In the illustrated embodiment, the computing device 200 includes a chassis 202 that houses the components of the computing device 200, only some of which are illustrated and described below. For example, the chassis 202 may house a BIOS processing system (not illustrated, but which may include the processor 102 discussed above with reference to FIG. 1 such as, for example, a Central Processing Unit (CPU) and/or other BIOS processing firmware known in the art) and a BIOS memory system (not illustrated, but which may be similar to the memory 114 discussed above with reference to FIG. 1 and may be provided by BIOS memory firmware known in the art) that is coupled to the BIOS processing system and that includes instructions that, when executed by the BIOS processing system, cause the BIOS processing system to provide a BIOS engine 204 that is configured to provide a BIOS for the computing device 200 that performs hardware initialization during boot of the computing device 200, provides runtime operations for an operating system and/or applications on the computing device 200 during runtime, and/or performs other conventional BIOS operations that would be apparent to one of skill in the art in possession of the present disclosure in addition to the OOB BIOS update functionality performed by the BIOS engines and/or computing devices discussed in the specific examples provided below. However, while described as a “BIOS”, one of skill in the art in possession of the present disclosure will appreciate how the BIOS discussed below may be provided according to Unified Extensible Firmware Interface (UEFI) specifications while remaining within the scope of the present disclosure as well.

As will be appreciated by one of skill in the art in possession of the present disclosure, the BIOS provided by the BIOS engine 204 is described in the examples below as the component of the computing device 200 that is updated using the OOB component update system of the present disclosure. However, while a specific BIOS update process for the BIOS is described below, one of skill in the art in possession of the present disclosure will appreciate how the computing device 200 may include graphics processing systems (e.g., Graphics Processing Units (GPUs)), Local Area Network (LAN) On Motherboard (LOM) devices, Network Interface Controller (NIC) devices, Complex Programmable Logic Devices (CPLDs), storage controllers, and/or any of a variety of other components that may be updated similarly as described for the BIOS below.

The chassis 302 may also house a BIOS storage system (not illustrated, but which may be similar to the storage 108 discussed above with reference to FIG. 1 and may be provided by BIOS storage devices known in the art) that is coupled to the BIOS engine 304 (e.g., via a coupling between the BIOS storage system and the BIOS processing system) and that includes a BIOS database 306 that is configured to store any of the information utilized by the BIOS engine 304 discussed below.

As illustrated, the chassis 202 may house a plurality of computing components 208, and one of skill in the art in possession of the present disclosure will appreciate how the computing components may include hardware components, software components, database components, and/or any other computing components that one of skill in the art in possession of the present disclosure will recognize as providing any of the runtime parameters described below that one of skill in the art in possession of the present disclosure will recognize has providing the functionality discussed below.

The chassis 202 also houses a Baseboard Management Controller (BMC) device 210 that is coupled to the BIOS engine 204 (e.g., via a coupling between the BMC device 210 and the BIOS processing system) and that may be provided by an integrated DELL® Remote Access Controller (iDRAC) included in server devices available from DELL® Inc. of Round Rock, Texas, United States, an “OpenBMC” device provided according to the OpenBMC standards, and/or other BMC devices that would be apparent to one of skill in the art in possession of the present disclosure. As such, one of skill in the art in possession of the present disclosure will recognize how the BMC device 210 may be configured to provide Out-Of-Band (OOB) management for the computing device 200 via the use of mostly separate resources from the computing device 200 to provide a browser-based interface or Command Line Interface (CLI) for managing and monitoring hardware in the computing device 200, as well as to perform the OOB component update functionality described below.

The BMC device 210 may include a BMC processing system (not illustrated, but which may be similar t the processor 102 discussed above with reference to FIG. 1 such as, for example, a service processor) and a BMC memory system (not illustrated, but which may be similar to the memory 114 discussed above with reference to FIG. 1) that is coupled to the BMC processing system and that includes instructions that, when executed by the BMC processing system, cause the BMC processing system to provide a BMC engine 210a that is configured to perform the functionality of the BMC engines, BMC subsystems, and/or BMC devices discussed below. As will be appreciated by one of skill in the art in possession of the present disclosure, in the embodiments provided below, the BMC engine 210a is configured to provide the OOB component update engines and OOB BIOS update engines discussed below. The BMC device 210 may also include a BMC storage system (not illustrated, but which may be similar to the storage 108 discussed above with reference to FIG. 1 and may be provided by BMC storage devices known in the art) that is coupled to the BMC engine 210a (e.g., via a coupling between the BMC storage system and the BIOS processing system) and that includes a BMC database 210b that is configured to store any of the information utilized by the BMC engine 210a discussed below.

The BMC device 210 may also include a communication system 210c that is coupled to the BMC engine 210a (e.g., via a coupling between the communication system 308 and the BMC processing system) and that may be provided by a Network Interface Controller (NIC) and/or any other communication components that would be apparent to one of skill in the art in possession of the present disclosure. However, while a specific computing device 200 has been illustrated and described, one of skill in the art in possession of the present disclosure will recognize that computing devices (or other devices operating according to the teachings of the present disclosure in a manner similar to that described below for the computing device 200) may include a variety of components and/or component configurations for providing conventional computing device functionality, as well as the OOB component update functionality discussed below, while remaining within the scope of the present disclosure as well.

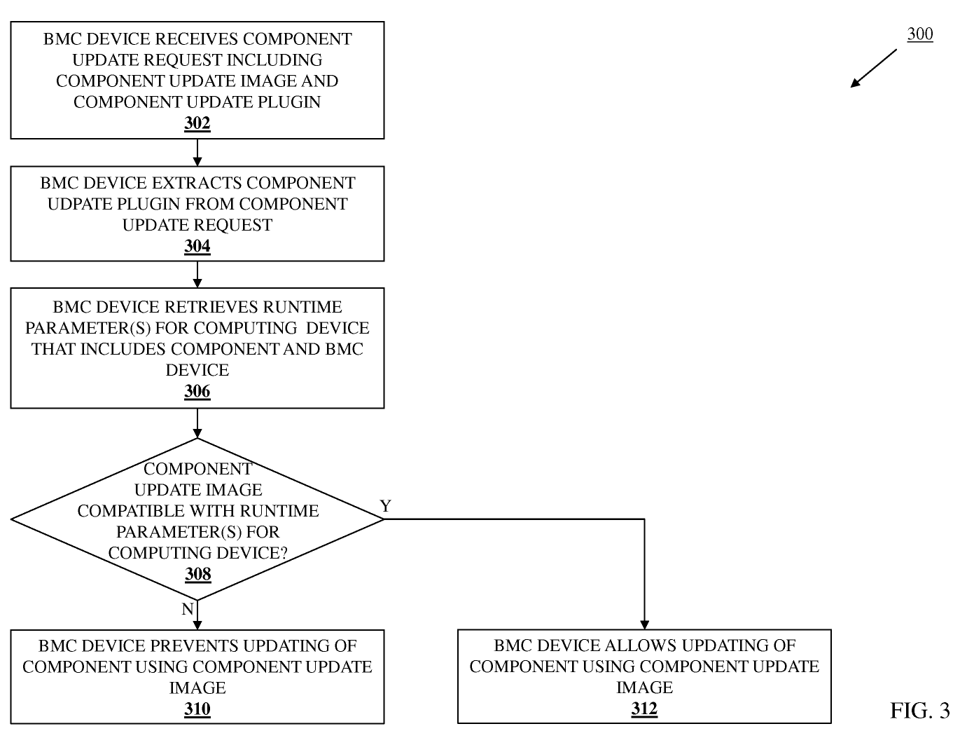

Referring now to FIG. 3, an embodiment of a method 300 for performing Out-Of-Band (OOB) updates for a component in a computing device is illustrated. As discussed below, the systems and methods of the present disclosure provide a component update plugin that is executable by a BMC device to determine whether runtime parameter(s) for a computing device that includes the BMC device are compatible with a component update image for updating a component in the computing device. For example, the OOB component update system of the present disclosure may include a computing device having BMC device coupled to a component. The BMC device receives a component update request that includes a component update image for updating the component, and a component update plugin. The BMC device then retrieves runtime parameter(s) for the computing device, and executes the component update plugin to determine whether the component update image is compatible with the runtime parameter(s). In response to the execution of the component update plugin determining that the component update image is not compatible with the runtime parameter(s), the BMC device prevents the updating of the component using the component update image. In response to the execution of the component update plugin determining that the component update image is compatible with the runtime parameter(s), the BMC device allows the updating of the component using the component update image. As such, the unavailability of a component being updated in a computing device is prevented until it is confirmed that the component update image for that component is compatible with the runtime parameter(s) of that computing device.

As will be appreciated by one of skill in the art in possession of the present disclosure, the systems and methods of the present disclosure eliminate the issues in conventional OOB BIOS update systems that require the performance of a reboot of the computing device 200 in order to check the compatibility of the BIOS update image with a runtime configuration of the computing device, which as discussed above can result in the unavailability/downtime of computing devices when the BIOS update image is not compatible with the runtime configuration of that computing device. While another solution to such issues would be to configure the BMC code of the BMC device that enables the OOB BIOS update to check the compatibility of the BIOS update image with a runtime configuration of the computing device, such solutions are not scalable as they create a dependency between BIOS updates and the BMC code that requires updates to the BMC code when any updates to the BIOS are desired, and such BMC code updates are resource intensive and can negatively affect First To Market (FTM) goals, Time To Market (TTM) goals, and the time required to release BIOS updates.

As will be appreciated by one of skill in the art in possession of the present disclosure, the systems and methods of the present disclosure do not require changes to the BMC code each time a BIOS update is required, and rather simply require a BMC development team to configure the BMC code for the BMC device to extract and execute the BIOS update plugin described below, with the BIOS development team developing the BIOS update plugin for any particular BIOS update and providing with a BIOS update image for that BIOS update as described below. As such, the complexity in enabling the OOB BIOS updates described below is reduced from coordinating BIOS code and BMC code development to simply using developer cross-compilation flags that allow the coordinate operations described below by the BIOS engine 204 provided by the BIOS processing system and the BMC engine provided by the BMC processing system.

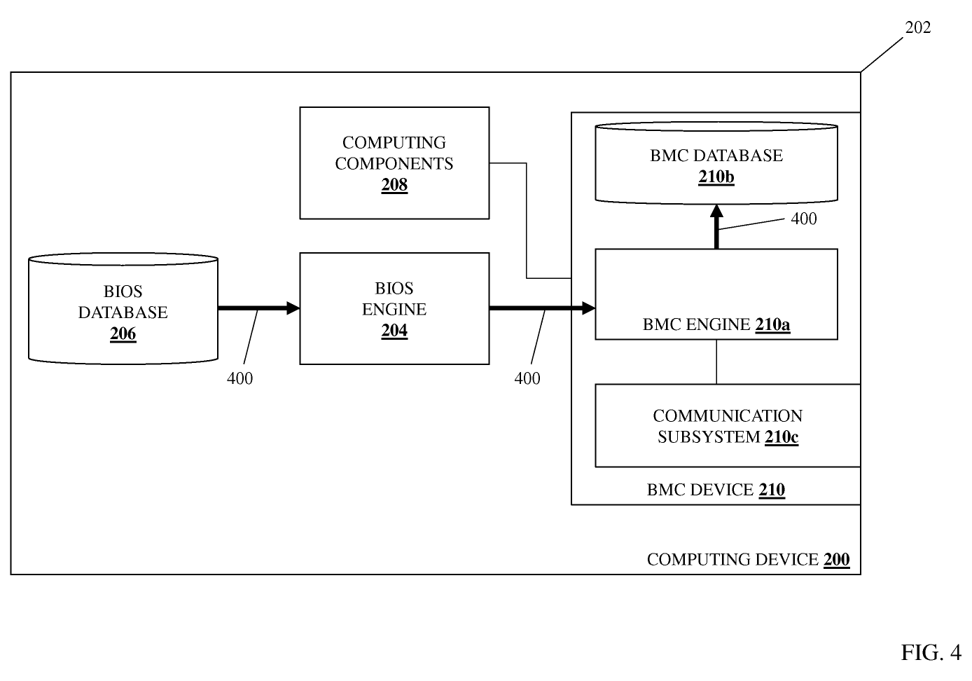

With reference to FIG. 4, prior to the method 400 and in the specific example described below in which the component being updated in the computing device 200 is provided by the BIOS provided by the BIOS engine 204, the BIOS engine 204 and the BMC engine 210a in the BMC device 210 may perform computing device identifier storage operations 400 that include the BIOS engine 204 retrieving a computing device identifier (e.g., a “service tag”, a computing platform identifier for a computing platform that includes the computing device 200, and/or other computing device identifiers known in the art) from the BIOS database 206 and providing the computing device identifier to the BMC engine 210a, with the BMC engine 210a storing that computing device identifier in the BMC database 210b (e.g., in a BIOS header file included in the BMC database 210b and/or in any other storage structure that would be apparent to one of skill in the art in possession of the present disclosure).

As will be appreciated by one of skill in the art in possession of the present disclosure and as discussed below, the computing device identifier storage operations 400 may be performed to allow the BMC engine 210a in the BMC device 210 to perform a relatively quick conventional BIOS update image/computing device identifier check of whether the BIOS update image described below was developed for the computing platform that includes the computing device 200, but embodiments in which the computing device identifier is retrieved from the BIOS database 206 and used to perform the relatively quick conventional component update check during the method 300 will fall within the scope of the present disclosure as well. Furthermore, while the computing device identifier storage operations 400 are described as being performed for embodiments in which the component being updated is a BIOS, one of skill in the art in possession of the present disclosure will appreciate how similar operations may be performed in association with the updating of other components in the computing device 200 while remaining within the scope of the present disclosure as well.

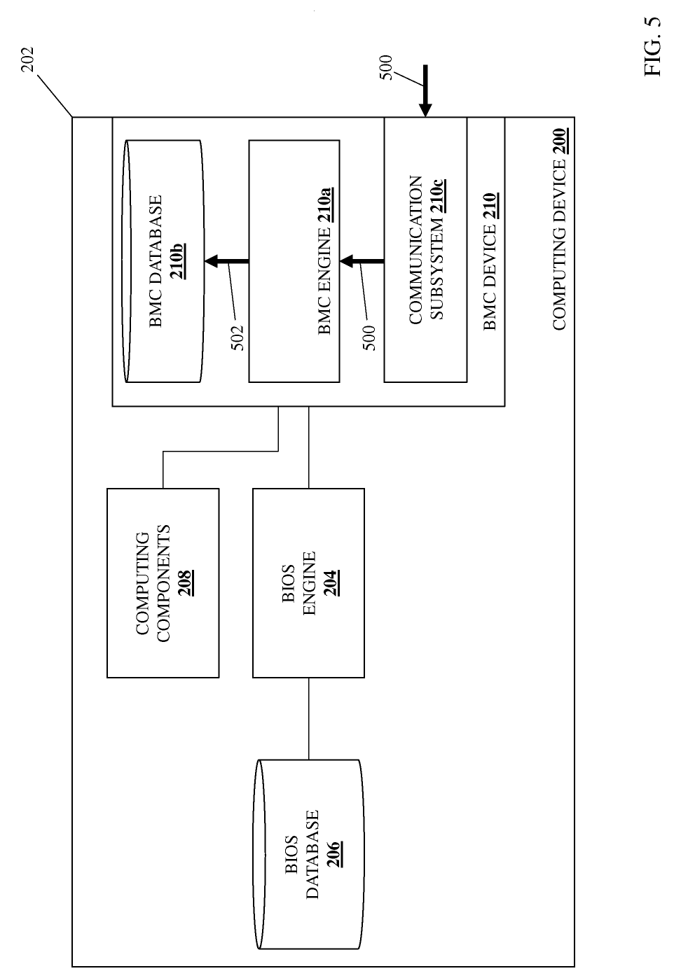

The method 300 begins at block 302 where a BMC device receives a component update request including a component update image and a component update plugin. With reference to FIG. 5, in an embodiment of block 302, the BMC engine 210a in the BMC device 210 may perform component update request receiving operations 500 that include receiving a component update request via the communication subsystem 210c. For example, a user may use a management device (e.g., a desktop computing device, a laptop/notebook computing device, a tablet computing device, a mobile phone, etc.) to generate the component update request that includes a component update image for updating a component in the computing device, and a component update plugin, and then transmit that component update request via a network such that the BMC engine 210a in the BMC device 210 receives that component update request via the communication subsystem 210c and stores that component update request in the BMC database 210b in the BMC device 210. As will be appreciated by one of skill in the art in possession of the present disclosure, the BMC engine 210a in the BMC device 210 may perform any of a variety of authentication operations known in the art on the component update request in order ensure its authenticity prior to storing it in the BMC database 210b in the BMC device 210.

Continuing with the specific example above in which the component being updated is a BIOS provided by the BIOS engine 204, at block 302 the BMC engine 210a may receive the component update request provided by a DELL® Update Package (DUP) provided by DELL® Inc. of Round Rock, Texas, United States, with the DUP including a BIOS update image that is configured to update the BIOS provided by the BIOS engine 204, and including a BIOS update plugin that is configured to be used by the BMC engine 210a in the BMC device 210 as described in further detail below, and the BMC engine 210a may perform any of a variety of authentication operations known in the art on the DUP (e.g., authenticating a computing device provider signature included in the DUP) to ensure the authenticity of the DUP (which, in turn, ensures the authenticity of the BIOS update image and the BIOS update plugin). However, while a specific example of a BIOS update request including a BIOS update image and a BIOS update plugin is illustrated and described, one of skill in the art in possession of the present disclosure will appreciate how other components may be updated with component update images and component update plugins similarly as described below for the BIOS provided by the BIOS engine 204.

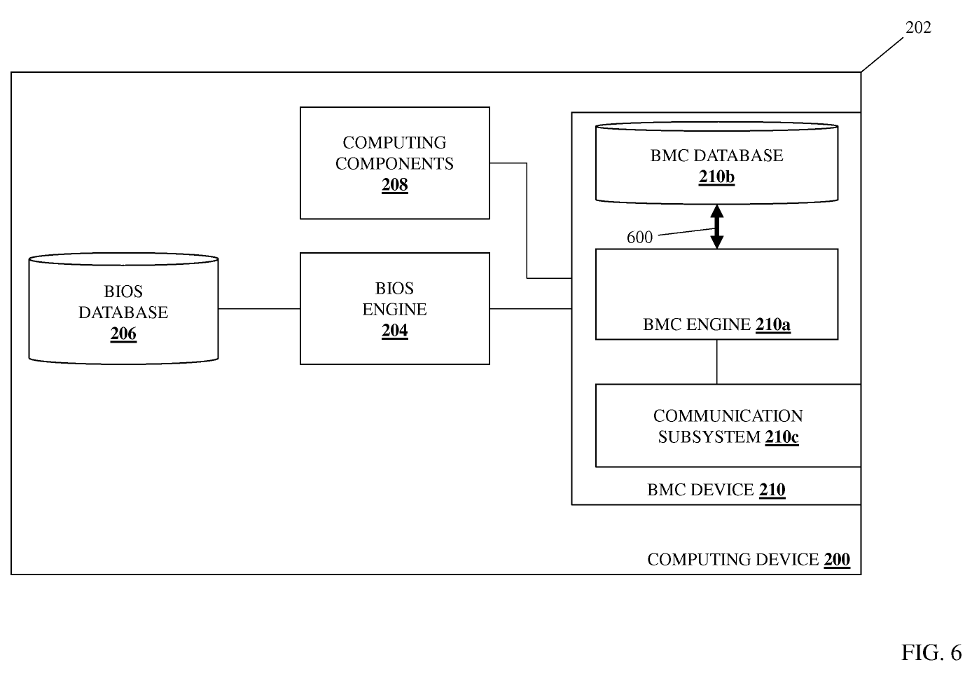

With reference to FIG. 6, and continuing with the specific example above in which the component being updated is a BIOS provided by the BIOS engine 204, the BMC engine 210a in the BMC device 210 may perform the conventional BIOS update image/computing device identifier check operations 600 discussed above that include determining whether the BIOS update image was developed for the computing platform that includes the computing device 200 by, for example, determining whether a computing device identifier that is included in the BIOS update image matches the computing device identifier that was retrieved from the BIOS database 206 and stored in the BMC database 210b in the BMC device 210 (e.g., whether a computing platform identifier in the BIOS image update matches the computing platform identifier for the computing platform that includes the computing device 200 and that was retrieved from the BIOS database 206 and stored in the BMC database 210b in the BMC device 210).

As will be appreciated by one of skill in the art in possession of the present disclosure, the conventional BIOS update image/computing device identifier check operations 600 allow the BMC engine 210a to perform a relatively quick check of whether the BIOS update image received at block 302 was developed for the computing platform that includes the computing device 200, but does not provide any information about whether that BIOS update image is compatible with the runtime configuration of the computing device 200, described in further detail below.

The remainder of the method 400 assumes that the conventional BIOS update image/computing device identifier check operations 600 determine that the BIOS update image received at block 302 was developed for the computing platform that includes the computing device 200 (i.e., the computing device identifier/computing platform identifier that is included in the BIOS update image matches the computing device identifier/computing platform identifier that was retrieved from the BIOS database 206 and stored in the BMC database 210b in the BMC device 210), but one of skill in the art in possession of the present disclosure will appreciate how a determination that the BIOS update image received at block 302 was not developed for the computing platform that includes the computing device 200 (i.e., the computing device identifier/computing platform identifier that is included in the BIOS update image does not match the computing device identifier/computing platform identifier that was retrieved from the BIOS database 206 and stored in the BMC database 210b in the BMC device 210) will result in BMC engine 210a in the BMC device ending the BIOS update process discussed below.

Furthermore, while the conventional BIOS update image/computing device identifier check operations 600 have been described with regard to an update to a BIOS provided by the BIOS engine 204, one of skill in the art in possession of the present disclosure will appreciate how similarly component update image/computing device identifier check operations may be performed for other types of components while remaining within the scope of the present disclosure as well.

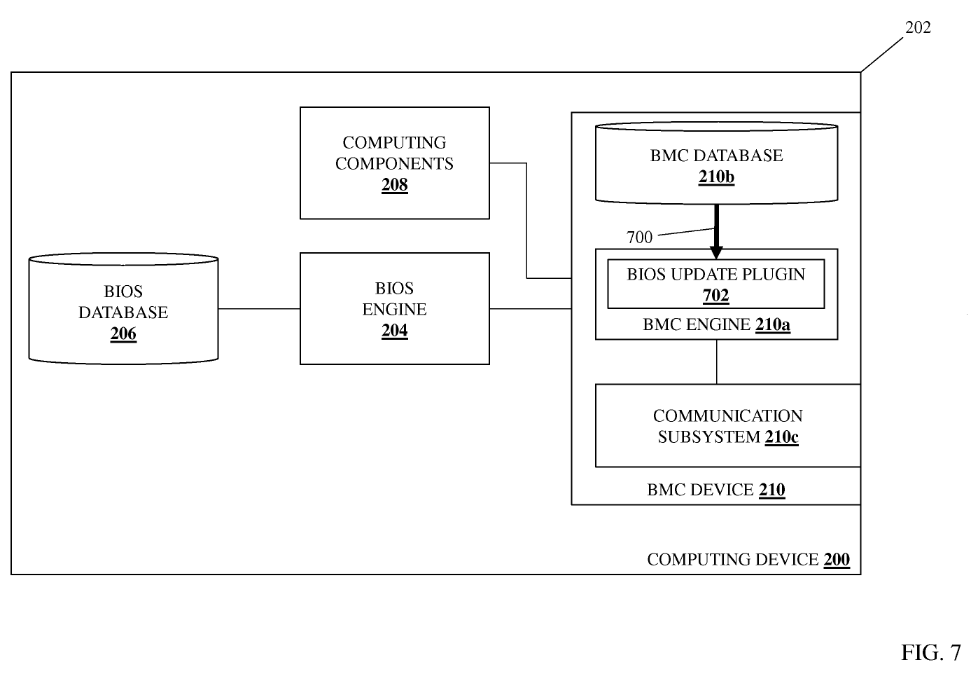

The method 300 then proceeds to block 304 where the BMC device extracts the component update plugin. With reference to FIG. 7, in an embodiment of block 304, the BMC engine 210a in the BMC device 210 may perform component update plugin extraction operations 700 that include extracting the component update plugin (e.g., the BIOS update plugin 702) from the component update request (e.g., the DUP) that was stored in the BMC database 210b of the BMC device 210 using any of a variety of plugin extraction techniques that one of skill in the art in possession of the present disclosure would recognize as configuring the BMC engine 210a in the BMC device 210 to subsequently execute the component update plugin (e.g., the BIOS update plugin 702) as described in further detail below.

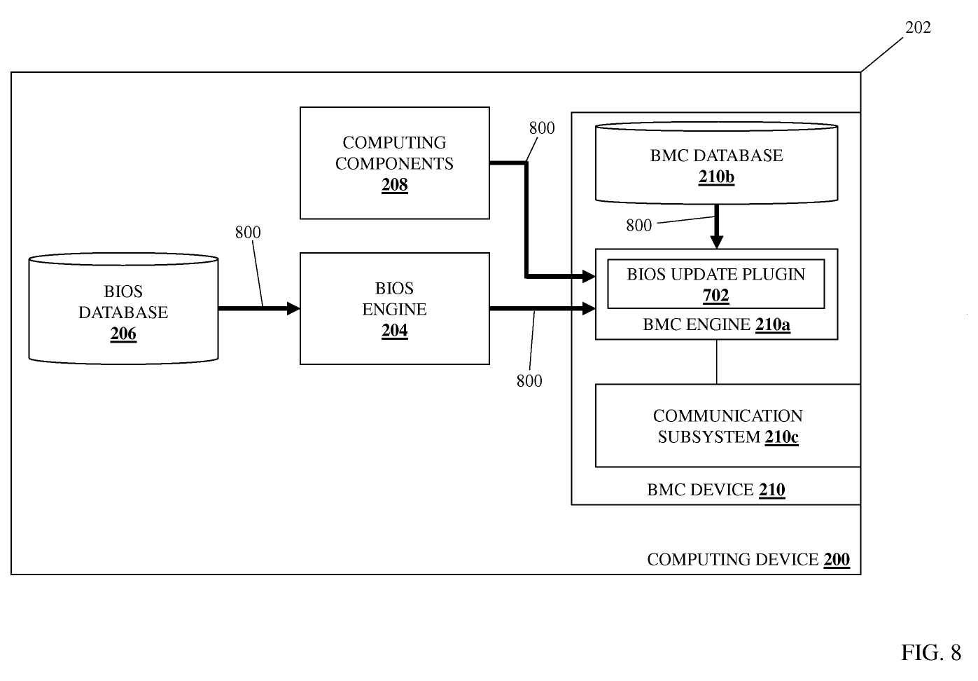

The method 300 then proceeds to block 306 where the BMC device retrieves at least one runtime parameter for a computing device that includes the component and the BMC device. With reference to FIG. 8, in an embodiment of block 306, the BMC engine 210a in the BMC device 210 may perform runtime parameter retrieval operations 800 that include retrieving runtime parameters for the computing device 200. Continuing with the specific example above in which the component being updated is a BIOS provided by the BIOS engine 204, the BMC engine 210a in the BMC device 210 may retrieve the runtime parameters for the computing device 200 from the BIOS database 206 (e.g., via the BIOS engine 204), from the BIOS engine 204, from any of the computing components 208, from the BMC database 210b in the BMC device 210, and/or from any other runtime parameter source of runtime parameters for the computing device 200 that one of skill in the art in possession of the present disclosure would recognize as providing the functionality described below.

For example, the runtime parameters for the computing device 200 retrieved at block 306 may include the retrieval of a processing system identifier (e.g., from the BIOS engine 204) that identifies the BIOS processing system (e.g., the CPU discussed above) that is being used to provide the BIOS engine 204. In another example, the runtime parameters for the computing device 200 retrieved at block 306 may include identify of a lockdown mode for the BMC device 210 in the computing device 200 from the BMC database 210b in the BMC device 210. In another example, the runtime parameters for the computing device 200 retrieved at block 306 may include the retrieval of BIOS downgrade issue information from the BMC database 210b in the BMC device 210. However, while several specific examples of runtime parameters for the computing device 200 have been described, one of skill in the art in possession of the present disclosure will appreciate how any of a variety of runtime parameters for the computing device 200 (e.g., security policies for the computing device 200 from the BIOS database 206 that were set via the BIOS provided by the BIOS engine 204, runtime parameters associated with any of the computing components 208, etc.) will fall within the scope of the present disclosure as well.

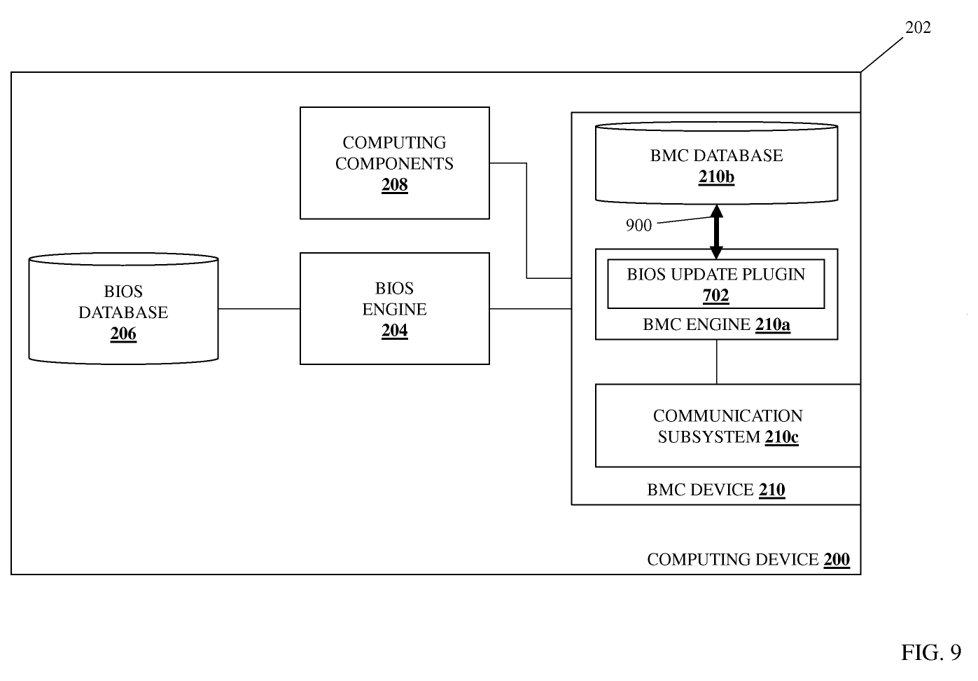

The method 300 then proceeds to decision block 308 where the method 300 proceeds depending on whether the execution of the component update plugin determines whether component update image is compatible with the at least one runtime parameter for the computing device. With reference to FIG. 9, in an embodiment of decision block 308 and continuing with the specific example above in which the component being updated is a BIOS provided by the BIOS engine 204, the BMC engine 210a in the BMC device 210 may execute the BIOS update plugin 702 to perform BIOS update image/computing device runtime parameter compatibility check operations 900 that include determining whether the BIOS update image included in the DUP that is stored in the BMC database 210b is compatible with the runtime parameters for the computing device 200 that were retrieved at block 306.

For example, at decision block 308 the execution of the BIOS update plugin 702 to perform the BIOS update image/computing device runtime parameter compatibility check operations 900 may include determining whether the BIOS update image included in the DUP that is stored in the BMC database 210b is compatible with the runtime parameter provided by the processing system identifier that identifies the BIOS processing system that is being used to provide the BIOS engine 204. As will be appreciated by one of skill in the art in possession of the present disclosure, the BIOS update image may identify processing systems that are compatible with that BIOS update image using any of a variety of techniques known in the art, and the comparison of the runtime parameter provided by the processing system identifier with the compatible processing system(s) identified in the BIOS update image will provide for a determination of whether the BIOS update image is compatible with the processing system currently included in the computing device 200.

In another example, at decision block 308 the execution of the BIOS update plugin 702 to perform the BIOS update image/computing device runtime parameter compatibility check operations 900 may include determining whether the BIOS update image included in the DUP that is stored in the BMC database 210b is compatible with the runtime parameter that identifies the lockdown mode for the BMC device 210. As will be appreciated by one of skill in the art in possession of the present disclosure, the lockdown mode for the BMC device 210 may have been set by a user to prevent most changes to the computing device 200 and in a specific example may prevent BIOS feature updates while allowing BIOS security updates, and the comparison of the runtime parameter that identifies the lockdown mode for the BMC device 210 with the BIOS update image will provide for a determination of whether the BIOS update image provides a BIOS feature update or a BIOS security update and, thus, whether the BIOS update image is compatible with the lockdown mode for the BMC device 210.

In yet another example, at decision block 308 the execution of the BIOS update plugin 702 to perform the BIOS update image/computing device runtime parameter compatibility check operations 900 may include determining whether the BIOS update image included in the DUP that is stored in the BMC database 210b is compatible with the runtime parameter provided by the BIOS downgrade issue information retrieved from the BMC device 210. As will be appreciated by one of skill in the art in possession of the present disclosure, the BIOS downgrade issue information retrieved from the BMC device 210 may identify BIOS images with known security vulnerabilities (e.g., previous versions of BIOS images for which security issues have been identified), and the comparison of the runtime parameter provided by the BIOS downgrade issue information retrieved from the BMC device 210 with the BIOS update image will provide for a determination of whether the BIOS update image provides a BIOS image “downgrade” to a BIOS image with a known security vulnerability and, thus, whether the BIOS update image is compatible with the BIOS downgrade issue information retrieved from the BMC device 210.

However, while several specific examples of compatibility checks between BIOS update images and runtime parameters have been described, one of skill in the art in possession of the present disclosure will appreciate how compatibility checks between BIOS update images and any of a variety of runtime parameters, or compatibility checks between component update images and any of a variety of runtime parameters, will fall within the scope of the present disclosure as well.

If, at decision block 308, the execution of the component update plugin determines that the component update image is not compatible with the at least one runtime parameter for the computing device, the method 300 proceeds to block 310 where the BMC device prevents the updating of the component using the component update image. In an embodiment, at block 310 and continuing with the specific example above in which the component being updated is a BIOS provided by the BIOS engine 204, the execution of the BIOS update plugin 702 by the BMC engine 210a in the BMC device 210 to perform BIOS update image/computing device runtime parameter compatibility check operations 900 may include determining that the BIOS update image included in the DUP that is stored in the BMC database 210b is not compatible with the runtime parameters for the computing device 200 that were retrieved at block 306 and, in response, the BMC engine 210 may prevent the use of the BIOS update image to update the BIOS provided by the BIOS engine 204.

For example, at decision block 308 the execution of the BIOS update plugin 702 to perform the BIOS update image/computing device runtime parameter compatibility check operations 900 may include determining that the BIOS update image included in the DUP that is stored in the BMC database 210b is not compatible with the runtime parameter provided by the processing system identifier that identifies the BIOS processing system that is being used to provide the BIOS engine 204 and, in response, at block 310 the BMC engine 210a may prevent the use of the BIOS update image to update the BIOS provided by the BIOS engine 204 due to that BIOS update image not being compatible with the processing system currently inlcuded in the computing device 200.

In another example, at decision block 308 the execution of the BIOS update plugin 702 to perform the BIOS update image/computing device runtime parameter compatibility check operations 900 may include determining that the BIOS update image included in the DUP that is stored in the BMC database 210b is not compatible with the runtime parameter that identifies the lockdown mode for the BMC device 210 based on that BIOS update image providing a BIOS feature update and, in response, at block 310 the BMC engine 210a may prevent the use of the BIOS update image to update the BIOS provided by the BIOS engine 204 due to that BIOS update image not being compatible with the lockdown mode for the BMC device 210 that forbids BIOS feature updates to the BIOS provided by the BIOS engine 204.

In yet another example, at decision block 308 the execution of the BIOS update plugin 702 to perform the BIOS update image/computing device runtime parameter compatibility check operations 900 may include determining that the BIOS update image included in the DUP that is stored in the BMC database 210b is not compatible with the runtime parameter provided by the BIOS downgrade issue information retrieved from the BMC device 210 and, in response, at block 310 the BMC engine 210a may prevent the use of the BIOS update image to update the BIOS provided by the BIOS engine 204 due to that BIOS update image not being compatible with the BIOS downgrade information that identifies the BIOS update image as providing a “downgrade” to a BIOS image with known security vulnerabilities.

However, while several specific examples of the prevention of the use of BIOS update images to update a BIOS based on particular runtime parameters have been described, one of skill in the art in possession of the present disclosure will appreciate how the use of BIOS update images to update a BIOS may be prevented based on any of a variety of runtime parameters, or the use of component update images to update a component may be prevented based on any of a variety of runtime parameters, while remaining within the scope of the present disclosure as well.

If, at decision block 308, the execution of the component update plugin determines that the component update image is compatible with the at least one runtime parameter for the computing device, the method 300 proceeds to block 312 where the BMC device allows the updating of the component using the component update image. In an embodiment of block 312, and continuing with the specific example above in which the component being updated is a BIOS provided by the BIOS engine 204, the execution of the BIOS update plugin 702 by the BMC engine 210a in the BMC device 210 to perform BIOS update image/computing device runtime parameter compatibility check operations 900 may include determining that the BIOS update image included in the DUP that is stored in the BMC database 210b is compatible with the runtime parameters for the computing device 200 that were retrieved at block 306 and, in response, the BMC engine 210 may allow the use of the BIOS update image to update the BIOS provided by the BIOS engine 204.

For example, at decision block 308 the execution of the BIOS update plugin 702 to perform the BIOS update image/computing device runtime parameter compatibility check operations 900 may include determining that the BIOS update image included in the DUP that is stored in the BMC database 210b is compatible with the runtime parameter provided by the processing system identifier that identifies the BIOS processing system that is being used to provide the BIOS engine 204 and, in response, at block 312 the BMC engine 210a may allow the use of the BIOS update image to update the BIOS provided by the BIOS engine 204 due to that BIOS update image being compatible with the processing system currently included in the computing device 200.

In another example, at decision block 308 the execution of the BIOS update plugin 702 to perform the BIOS update image/computing device runtime parameter compatibility check operations 900 may include determining that the BIOS update image included in the DUP that is stored in the BMC database 210b is compatible with the runtime parameter provided by the lockdown mode for the BMC device 210 based on that BIOS update image providing a BIOS security update and, in response, at block 312 the BMC engine 210a may allow the use of the BIOS update image to update the BIOS provided by the BIOS engine 204 due to that BIOS update image being compatible with the lockdown mode for the BMC device 210 that allows BIOS security updates to the BIOS provided by the BIOS engine 204.

In yet another example, at decision block 308 the execution of the BIOS update plugin 702 to perform the BIOS update image/computing device runtime parameter compatibility check operations 900 may include determining that the BIOS update image included in the DUP that is stored in the BMC database 210b is compatible with the runtime parameter provided by the BIOS downgrade issue information retrieved from the BMC device 210 and, in response, at block 312 the BMC engine 210a may allow the use of the BIOS update image to update the BIOS provided by the BIOS engine 204 due to that BIOS update image being compatible with the BIOS downgrade information that identifies the BIOS update image as not providing a “downgrade” to a BIOS image with known security vulnerabilities.

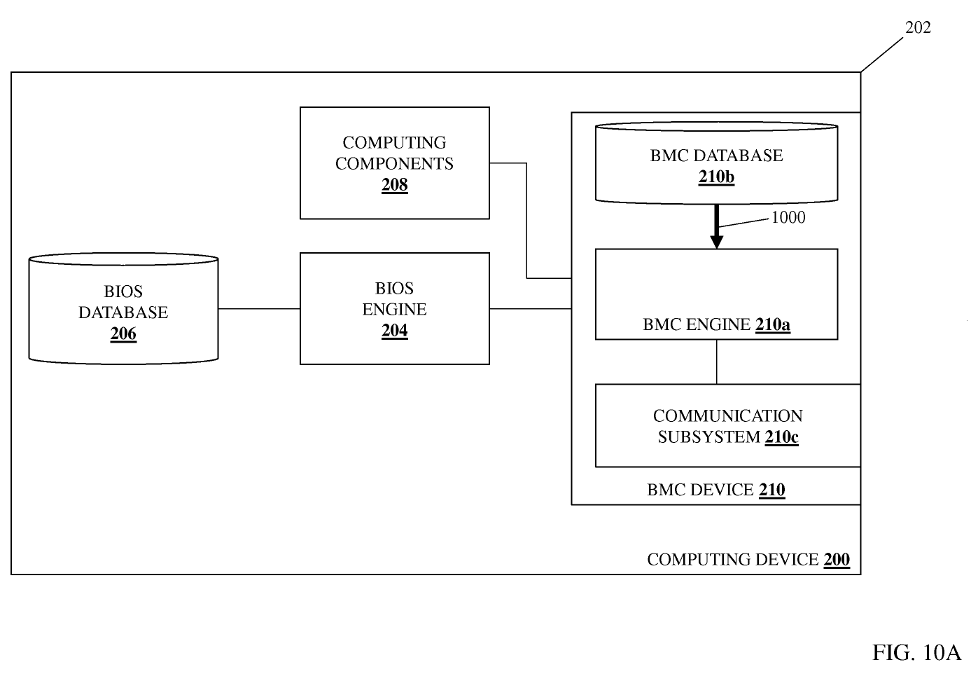

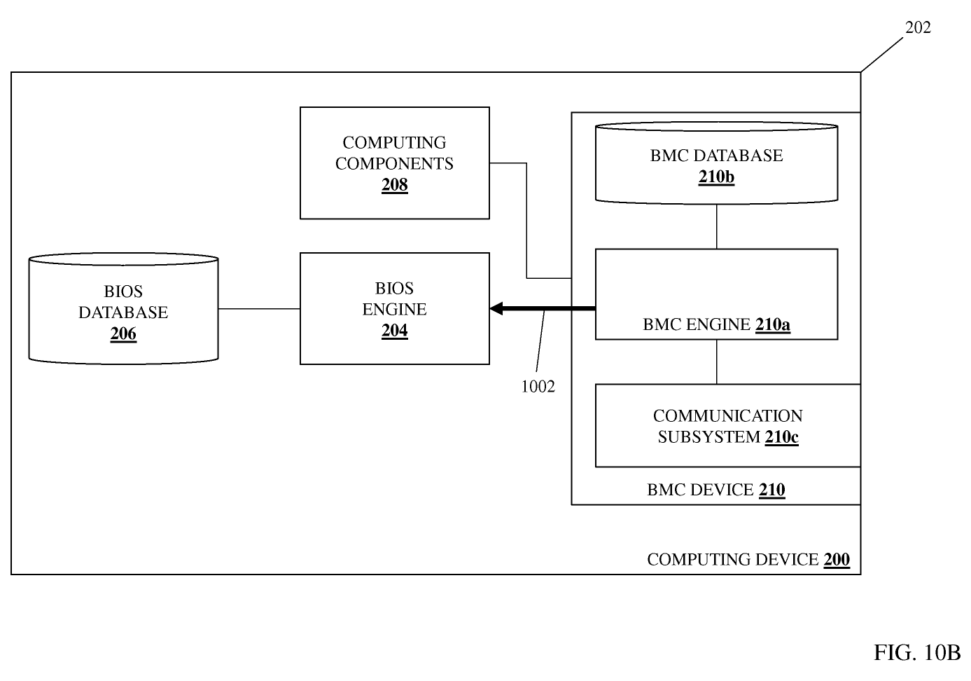

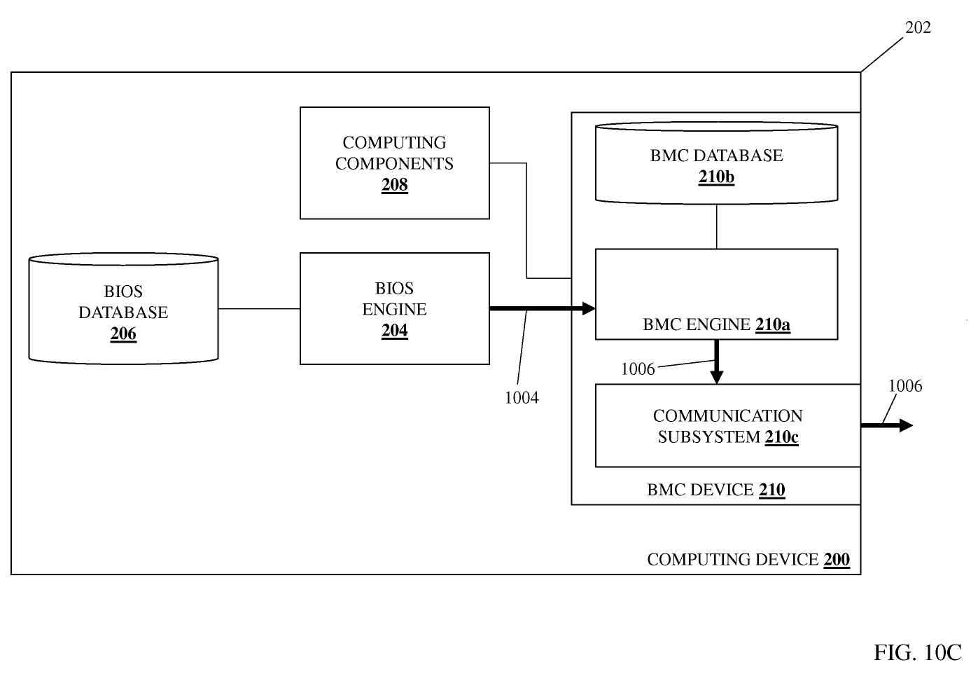

With reference to FIG. 10A, the allowing of the use of the BIOS update image to update the BIOS provided by the BIOS engine 204 at block 312 may include the BMC engine 210a in the BMC device 210 performing BIOS update image staging operations 1000 that include providing the BIOS update image in a memory subsystem that is shared with the BIOS engine 204, and while that memory subsystem is illustrated as being included in the BMC memory system that provides the BMC engine 210a, one of skill in the art in possession of the present disclosure will appreciate how the memory subsystem in which the BIOS update image is staged may be located outside the BMC device 210 while remaining within the scope of the present disclosure as well.

With reference to FIG. 10B, the allowing of the use of the BIOS update image to update the BIOS provided by the BIOS engine 204 at block 312 may also include the BMC engine 210a in the BMC device 210 causing a reboot of the computing device 200 such that, following that reboot and as part of the initialization of the computing device 200, the BIOS engine 204 performs BIOS update image retrieval operations 1002 that include retrieving the BIOS update image from the shared memory subsystem discussed above. However, while the BIOS update image has been described as being staged in a shared memory subsystem by the BMC engine 210a in the BMC device 210 and retrieved by the BIOS engine 204 following a reboot of the computing device 200, one of skill in the art in possession of the present disclosure will appreciate how other techniques for providing the BIOS update image to the BIOS engine (e.g., the BMC engine 210a streaming the BIOS image to the BIOS engine 204 following the reboot of the computing device 200) will fall within the scope of the present disclosure as well.

With reference to FIG. 10C, the allowing of the use of the BIOS update image to update the BIOS provided by the BIOS engine 204 at block 312 may also include the BIOS engine 204 using the BIOS update image to perform any of a variety of BIOS update operations that one of skill in the art in possession of the present disclosure will recognize update the BIOS provided by the BIOS engine 204, and following the completion of those BIOS update operations, the BIOS engine 204 may perform BIOS update completion message transmission operations 1004 that include generating and transmitting a BIOS update completion message to the BMC engine 210a in the BMC device 210. As can be seen in FIG. 10C, in response to receiving the BIOS update completion message, the BMC engine 210a may perform BIOS update request completion message transmission operations 1006 that include generating and transmitting a BIOS update request completion message via the communication subsystem 210c and to the user that provided the BIOS update request at block 302 (e.g., via a network to the management device used by the user as discussed above).

However, while several specific examples of the allowing of the use of BIOS update images to update a BIOS based particular runtime parameters have been described, one of skill in the art in possession of the present disclosure will appreciate how the use of BIOS update images to update a BIOS may be allowed based on any of a variety of runtime parameters and may be performed using any of a variety of BIOS update techniques known in the art, or the use of component update images to update a component may be allowed based on any of a variety of runtime parameters and may be performed using any of a variety of component update techniques known in the art, while remaining within the scope of the present disclosure as well.

As will be appreciated by one of skill in the art in possession of the present disclosure, the performance of the BIOS update image/computing device runtime parameter compatibility check at block 308 of the method 300 without performing a reboot of the computing device 200 as is required in conventional OOB BIOS update systems eliminates the unavailability/downtime of computing devices that occurs in conventional OOB BIOS update systems when the BIOS update image is not compatible with the runtime configuration of that computing device. Furthermore, while the update of some components in a computing device (e.g., the GPUs, LOM devices, NIC devices, and CPLDs) discussed above may not required a reboot of their computing device, one of skill in the art in possession of the present disclosure will appreciate how such component updates will still render those components unavailable, and thus the component update image/computing device runtime parameter compatibility checks performed as described above with reference to decision block 308 will operate to eliminate the unavailability/downtime of those components that would otherwise occur in conventional component update systems when the component update image is not compatible with the runtime configuration of their computing device.

Thus, systems and methods have been described that provide a component update plugin that is executable by a BMC device to determine whether runtime parameter(s) for a computing device that includes the BMC device are compatible with a component update image for updating a component in the computing device. For example, the OOB component update system of the present disclosure may include a computing device having BMC device coupled to a component. The BMC device receives a component update request that includes a component update image for updating the component, and a component update plugin. The BMC device then retrieves runtime parameter(s) for the computing device, and executes the component update plugin to determine whether the component update image is compatible with the runtime parameter(s). In response to the execution of the component update plugin determining that the component update image is not compatible with the runtime parameter(s), the BMC device prevents the updating of the component using the component update image. In response to the execution of the component update plugin determining that the component update image is compatible with the runtime parameter(s), the BMC device allows the updating of the component using the component update image. As such, the unavailability of a component being updated in a computing device is prevented until it is confirmed that the component update image for that component is compatible with the runtime parameter(s) of that computing device.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. An Out-Of-Band (OOB) component update system, comprising:
a computing device;
a component included in the computing device;
a Baseboard Management Controller (BMC) device that is included in the computing device, that is coupled to the component, and that is configured to:
receive a component update request that includes a component update image that is configured to update the component, and a component update plugin;
retrieve at least one runtime parameter for the computing device;
execute the component update plugin to determine whether the component update image is compatible with the at least one runtime parameter for the computing device;
prevent, in response to the execution of the component update plugin determining that the component update image is not compatible with the at least one runtime parameter for the computing device, the updating of the component using the component update image; and
allow, in response to the execution of the component update plugin determining that the component update image is compatible with the at least one runtime parameter for the computing device, the updating of the component using the component update image.

2. The system of claim 1, wherein the component is a Basic Input/Output System (BIOS).

3. The system of claim 2, wherein the allowing the updating of the component using the component update image includes causing a reboot of the computing device, and wherein the BIOS is configured to use a BIOS update image that provides the component update image to update the BIOS in response to the reboot of the computing device.

4. The system of claim 2, wherein the BMC device is configured to:
execute a BIOS update plugin that provides the component update plugin to determine whether a BIOS update image that provides the component update image is compatible with a processing system that is included in the computing device and that is identified by the at least one runtime parameter for the computing device.

5. The system of claim 1, wherein the preventing the updating of the component using the component update image includes preventing the component update request from causing the component to become unavailable.

6. The system of claim 1, wherein the BMC device is configured to:
authenticate the component update plugin.

7. An Information Handling System (IHS), comprising:
a Baseboard Management Controller (BMC) processing system; and
a BMC memory system that is coupled to the BMC processing system and that includes instructions that, when executed by the BMC processing system, cause the BMC processing system to provide an Out-Of-Band (OOB) component update engine that is configured to:
receive a component update request that includes a component update image that is configured to update a component, and a component update plugin;
retrieve at least one runtime parameter for a computing device that includes the component and a BMC device having the BMC processing system and the BMC memory system;
execute the component update plugin to determine whether the component update image is compatible with the at least one runtime parameter for the computing device;
prevent, in response to the execution of the component update plugin determining that the component update image is not compatible with the at least one runtime parameter for the computing device, the updating of the component using the component update image; and
allow, in response to the execution of the component update plugin determining that the component update image is compatible with the at least one runtime parameter for the computing device, the updating of the component using the component update image.

8. The IHS of claim 7, wherein the component is a Basic Input/Output System (BIOS).

9. The IHS of claim 8, wherein the allowing the updating of the component using the component update image includes causing a reboot of the computing device, and wherein the BIOS is configured to use a BIOS update image that provides the component update image to update the BIOS in response to the reboot of the computing device.

10. The IHS of claim 8, wherein the OOB component update engine is provided by an OOB BIOS update engine that is configured to:
execute a BIOS update plugin that provides the component update plugin to determine whether a BIOS update image that provides the component update image is compatible with a processing system that is included in the computing device and that is identified by the at least one runtime parameter for the computing device.

11. The IHS of claim 7, wherein the OOB component update engine is provided by an OOB BIOS update engine that is configured to:
execute a BIOS update plugin that provides the component update plugin to determine whether a BIOS update image that provides the component update image is compatible with a lockdown mode of the computing device that is identified by the at least one runtime parameter for the computing device;
prevent, in response to the execution of the component update plugin determining that the BIOS update image is not compatible with the lockdown mode of the computing device based on the BIOS update image providing a feature update to the BIOS that is identified by the at least one runtime parameter for the computing device, the updating of the component using the component update image; and
allow, in response to the execution of the component update plugin determining that the component update image is compatible with the lockdown mode of the computing device based on the BIOS update image providing a security update to the BIOS that is identified by the at least one runtime parameter for the computing device.

12. The IHS of claim 7, wherein the preventing the updating of the component using the component update image includes preventing the component update request from causing the component to become unavailable.

13. The IHS of claim 7, wherein the OOB component update engine is configured to:
authenticate the component update plugin.

14. A method for performing Out-Of-Band (OOB) updates for a component in a computing device, comprising:
receiving, by a Baseboard Management Controller (BMC) device, a component update request that includes a component update image that is configured to update a component, and a component update plugin;
retrieving, by the BMC device, at least one runtime parameter for a computing device that includes the component and the BMC device;
executing, by the BMC device, the component update plugin to determine whether the component update image is compatible with the at least one runtime parameter for the computing device;
preventing, by the BMC device in response to the execution of the component update plugin determining that the component update image is not compatible with the at least one runtime parameter for the computing device, the updating of the component using the component update image; and
allowing, by the BMC device in response to the execution of the component update plugin determining that the component update image is compatible with the at least one runtime parameter for the computing device, the updating of the component using the component update image.

15. The method of claim 14, wherein the component is a Basic Input/Output System (BIOS).

16. The method of claim 15, wherein the allowing the updating of the component using the component update image includes causing a reboot of the computing device, and wherein the method further comprises:
using, by the BIOS, a BIOS update image that provides the component update image to update the BIOS in response to the reboot of the computing device.

17. The method of claim 15, further comprising:
executing, by the BMC device, a BIOS update plugin that provides the component update plugin to determine whether a BIOS update image that provides the component update image is compatible with a processing system that is included in the computing device and that is identified by the at least one runtime parameter for the computing device.

18. The method of claim 14, further comprising:
executing, by the BMC device, a BIOS update plugin that provides the component update plugin to determine whether a BIOS update image that provides the component update image is compatible with a lockdown mode of the computing device that is identified by the at least one runtime parameter for the computing device; and
preventing, by the BMC device in response to the execution of the component update plugin determining that the BIOS update image is not compatible with the lockdown mode of the computing device based on the BIOS update image providing a feature update to the BIOS that is identified by the at least one runtime parameter for the computing device, the updating of the component using the component update image; and
allowing, by the BMC device in response to the execution of the component update plugin determining that the component update image is compatible with the lockdown mode of the computing device based on the BIOS update image providing a security update to the BIOS that is identified by the at least one runtime parameter for the computing device.

19. The method of claim 14, wherein the preventing the updating of the component using the component update image includes preventing the component update request from causing the component to become unavailable.

20. The method of claim 14, further comprising:
authenticating, by the BMC device, the component update plugin.
